(19) United States
(12) Patent Application Publication
(10) Pub. No.: US 2025/0033197 A1
(43) Pub. Date: Jan. 30, 2025

(54) CONTROL DEVICE, TEACHING DEVICE, AND MECHANICAL SYSTEM

(71) Applicant: FANUC CORPORATION, Yamanashi (JP)

(72) Inventor: Manabu HIRAKAWA, Yamanashi (JP)

(21) Appl. No.: 18/714,094

(22) PCT Filed: Jan. 14, 2022
(86) PCT No.: PCT/JP2022/001182

§ 371 Date: May 29, 2024

(51) Int. Cl. B25J 9/16

(52) U.S. Cl. CPC B25J 9/1628

(57) ABSTRACT

This control device comprises: a posture adjustment unit that, on the basis of reference information for the posture of a to-be-controlled part of a machine, adjusts the posture of the to-be-controlled part on the movement track thereof; and a control unit that controls the operation of the machine on the basis of the adjusted posture. The posture adjustment unit uses a reference point and/or a reference line as the reference information.

### FIELD

The present invention relates to a teaching technique and a control technique of a machine, and more particularly to a control device, a teaching device, and a mechanical system that suppress a rapid posture change of a control target part.

### BACKGROUND

In an operation program of a machine such as a robot and a machine tool, a position and a posture of a control target part that have been taught are associated with an operation instruction. For a given operation instruction, a position of an immediately preceding operation instruction is determined as a starting position, and a posture of the immediately preceding operation instruction is determined as a starting posture. A difference between positions of two consecutive operation instructions serves as a movement distance of a control target part, and a difference between postures of two consecutive operation instructions serves as a posture change amount of the control target part. In addition, an operation instruction includes a movement speed of a control target part, a movement time of the control target part taken for one operation instruction is determined from the movement speed and the movement distance, and a posture change speed is automatically determined from the movement time and the posture change amount. In other words, a teacher can specify a movement speed of a control target part, but may not specify the posture change speed of the control target part.

By the way, in work utilizing an operation trajectory of a tool set as a control target part for a machine, such as a welding tool, a coating tool, a deburring tool, a sealing tool, a cutting tool, a polishing tool, or a hemming tool, a rapid change in a posture of a tool may deteriorate work quality even when a movement speed of the tool is constant. Therefore, a teacher teaches a posture of a tool in such a way that a posture of a tool does not rapidly change. However, it is not easy to teach a posture of a tool in such a way that the posture of the tool changes smoothly (i.e. in such a way that a posture change speed of the tool becomes substantially constant).

FIGS. 15A to 15C are explanatory diagrams describing a problem in conventional posture teaching. As illustrated in FIG. 15A, there are three consecutive teaching points P1 to P3 on an operation trajectory of a tool, and a distance between the teaching points P1 and P2 is three times a distance between the teaching points P2 and P3, in which case, when a movement speed of the tool is taught to be constant, a posture change speed of the tool can be caused to be substantially constant by teaching a posture in such a way that a posture change amount of the tool between the teaching points P1 and P2 becomes three times a posture change amount of the tool between the teaching points P2 and P3.

However, as illustrated in FIG. 15B, when a posture of a tool is taught in such a way that a posture change amount of the tool between the teaching point P2 and the teaching point P3 becomes equal to or more than a posture change amount between the teaching point P1 and the teaching point P2, a posture change speed between the teaching point P2 and teaching point P3 is rapidly accelerated compared to a posture change speed between the teaching point P1 and teaching point P2, as illustrated in FIG. 15C, which therefore causes deterioration of work quality, such as welding quality, coating quality, deburring quality, sealing quality, cutting quality, and polishing quality due to a machine.

As can be seen from FIG. 15B, trial and error and experience are required in order to teach a posture by the human senses in such a way that a posture change amount of a tool becomes three times in a three-dimensional space. A skilled teacher can teach a posture of a tool in such a way that a posture change speed of the tool becomes substantially constant between the teaching points P1 to P3, but especially for an inexperienced teacher, it is not easy to teach a posture of a tool in such a way that a posture change speed of the tool becomes substantially constant. As related techniques related to the present application, the following are known.

PTL 1 describes a tool path correction device for machining using a tool, wherein regarding adjacent command points CP5 and CP6 in a tool movement path of the tool, a ratio AC5/D5 of an angle change amount AC5 of the tool to a movement amount D5 of the tool is calculated, and when the ratio AC5/D5 of the calculated angle change amount AC5 of the tool is equal to or more than a threshold value, a portion EP5 being a combination of the command points CP5 and CP6 in the movement path of the tool is determined to be a target for correction.

PTL 2 describes reading, into a variable Dpre, a posture data portion in a first row within a teaching data file output from a CAD system, then reading a posture data portion in a next row into a variable Dcur, evaluating a magnitude of a difference |Dpre−Dcur| between Dpre and Dcur, and when the difference is greater than a reference value, regarding that an articular angle has rapidly changed, performing conversion to alternative posture data, substituting the alternative posture data with the variable Dcur, and updating a content of the variable Dpre to a content of the variable Dcur.

PTL 3 describes calculating a posture of a tool attached to a tip of an industrial robot in such a way as to associate with a vertical direction vector perpendicular to a surface of a work at each teaching point, detecting a teaching point at which the calculated posture of the tool is inconstant, determining the detected teaching point as a singular point, recalculating a posture of the tool at the singular point, and determining a posture of the tool at each teaching point.

PTL 4 describes reducing a speed vP to a first condition speed v1 when an angle θ formed by a line segment extending from a teaching point P−1 on an upstream side of a movement path to a teaching point P where a speed is to be set and a line segment extending from the teaching point P to a teaching point P+1 on a downstream side is large, or reducing the speed vP to a second condition speed when a posture at the teaching point P greatly changes from a posture of a robot at the teaching point P−1 on the upstream side of the movement path.

### CITATION LIST

### Patent Literature

[PTL 1] WO 2020/021793
[PTL 2] Japanese Unexamined Patent Publication (Kokai) No. H04-268607
[PTL 3] Japanese Unexamined Patent Publication (Kokai) No. H09-254062
[PTL 4] Japanese Unexamined Patent Publication (Kokai) No. 2015-123517

### SUMMARY

### Technical Problem

An object of the present invention is, in view of the conventional problems, to provide a technique for suppressing a rapid posture change of a control target part of a machine.

### Solution to Problem

An aspect of the present disclosure provides a control device including: a posture adjustment unit configured to adjust, based on reference information of a posture of a control target part of a machine, the posture of the control target part on an operation trajectory of the control target part; and a control unit configured to control an operation of the machine, based on the adjusted posture, wherein the posture adjustment unit uses at least one of a reference point and a reference line as the reference information.

Another aspect of the present disclosure provides a teaching device including a posture adjustment unit configured to adjust, based on reference information of a posture of a control target part of a machine, the posture of the control target part on an operation trajectory of the control target part, wherein the posture adjustment unit uses at least one of a reference point and a reference line as the reference information.

A different aspect of the present disclosure provides a mechanical system comprising: a machine; a posture adjustment unit configured to adjust, based on reference information of a posture of a control target part of the machine, the posture of the control target part on an operation trajectory of the control target part; and a control unit configured to control an operation of the machine, based on the adjusted posture, wherein the posture adjustment unit uses at least one of a reference point and a reference line as the reference information.

### Advantageous Effects of Invention

According to one of the aspects of the present disclosure, a difference in a posture change speed of a control target part for each operation instruction is automatically lessened, and a control target part of a machine changes at a substantially constant posture change speed. In other words, since a rapid posture change of a control target part is suppressed, deterioration of work quality resulting from a machine can be suppressed.

### BRIEF DESCRIPTION OF DRAWINGS

FIG. 1 is a configuration diagram of a mechanical system according to a first embodiment.

FIG. 2 is a functional block diagram of the mechanical system according to the first embodiment.

FIG. 3 is an explanatory diagram describing one example of work for performing posture adjustment according to a reference point.

FIG. 4 is a top view of a tool before posture adjustment and a tool after posture adjustment according to a reference point.

FIG. 5 is a top view of the tool illustrating one example of a posture correction amount according to a reference point.

FIG. 6 is a diagram illustrating one example of a posture adjustment screen according to a reference point.

FIG. 7 is an explanatory diagram describing one example of work for performing posture adjustment according to a reference line.

FIG. 8 is a top view of a tool that has been subjected to posture adjustment according to a reference line.

FIG. 9A is a perspective view of a tool illustrating one example of a posture correction amount according to a reference line.

FIG. 9B is a top view of a tool illustrating one example of a posture correction amount according to a reference line.

FIG. 10 is a diagram illustrating one example of a posture adjustment screen according to a reference line.

FIG. 11 is a flowchart illustrating one example of a posture adjustment method according to the first embodiment.

FIG. 12 is a functional block diagram of a mechanical system according to a second embodiment.

FIG. 13 is a flowchart illustrating one example of a posture adjustment method according to the second embodiment.

FIG. 14 is a functional block diagram of a mechanical system according to a third embodiment.

FIG. 15A is an explanatory diagram describing a problem of conventional posture teaching.

FIG. 15B is an explanatory diagram describing a problem of conventional posture teaching.

FIG. 15C is an explanatory diagram describing a problem of conventional posture teaching.

### DESCRIPTION OF EMBODIMENTS

Hereinafter, embodiments according to the present disclosure will be described in detail with reference to accompanying drawings. The same or similar element is denoted by the same or similar reference sign in each of the drawings. In addition, the embodiments described below do not limit a technical scope of the invention described in claims and meaning of a term.

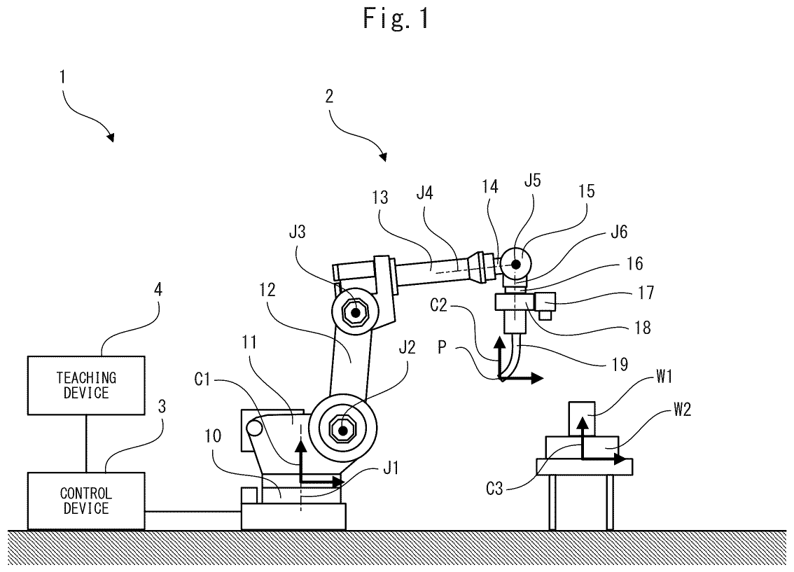

A configuration of a mechanical system 1 according to a first embodiment will be described below. FIG. 1 is a configuration diagram of the mechanical system 1 according to the first embodiment. The mechanical system 1 includes a machine 2, and a control device 3 that controls operation of the machine 2. In addition, although it is not necessary, the mechanical system 1 includes a teaching device 4 that teaches operation of the machine 2. The machine 2, the control device 3, and the teaching device 4 are communicatively connected to each other in a wired or wireless manner.

The machine 2 is formed of, but not limited to, a multi-jointed robot, and may be, in another embodiment, formed of other industrial robots such as a single joint robot, a parallel link robot, and a dual arm robot. In addition, in a different embodiment, the machine 2 may be formed of a robot in another manner such as a humanoid, instead of an industrial robot. Alternatively, in a still different embodiment, the machine 2 is not a robot, but may be formed of another industrial machine such as a machine tool, a construction machine, or an agricultural machine, or a machine in another manner such as a vehicle, an aircraft, or a rocket.

The machine 2 includes one or more mutually coupled links 10 to 16. The links 11 to 16 are formed of, but are not limited to, rotary links that rotate around predetermined axis lines J1 to J6, and may be, in another embodiment, formed of a linear link that moves linearly along a predetermined axis line. The zeroth link 10 is, for example, a base that is fixed at a predetermined position, and the first link 11 is, for example, a swing barrel that is supported rotatably with respect to the zeroth link 10 around the first axis line J1. The second link 12 is, for example, an upper arm supported rotatably with respect to the first link 11 around the second axis line J2 orthogonal to the first axis line J1, and the third link 13 is, for example, a forearm supported rotatably with respect to the second link 12 around the third axis line J3 parallel to the second axis line J2.

The fourth link 14 to the sixth link 16 are, for example, triaxial wrists attached to the third link 13. The fourth link 14 is, for example, a first wrist element supported rotatably with respect to the third link 13 around the fourth axis line J4 orthogonal to the third axis line J3, the fifth link 15 is, for example, a second wrist element supported rotatably with respect to the fourth link 14 around the fifth axis line J5 orthogonal to the fourth axis line J4, and the sixth link 16 is, for example, a third wrist element supported rotatably with respect to the fifth link 15 around the sixth axis line J6 orthogonal to the fifth axis line J5.

Although it is not necessary, the machine 2 may include a visual sensor 17 that acquires an image of a workspace in which a work target including a work or a tool exists. The visual sensor 17 is provided in a vicinity of a control target part P (in the present example, a tip of a tool 19) of the machine 2, but is not limited thereto, and may be provided in a different location from the machine 2 in another embodiment. The visual sensor 17 is formed of a two-dimensional camera, but is not limited thereto, and may be formed of a three-dimensional camera in another embodiment. From detection information of the visual sensor 17, the control device 3 or the teaching device 4 may derive a parameter such as a state of a work target, a position and a posture of a work target, a movement speed of a work target, a position and a posture of the control target part P of the machine 2, or a movement speed of the control target part P of the machine 2.

Although it is not necessary, the machine 2 may include a force detector 18 that detects force acting on the control target part P of the machine 2. The force detector 18 is formed of a force sensor that detects force in three axial directions and moment components around three axes, but is not limited thereto, and in another embodiment, may be formed of a force sensor that detects at least one or more pieces of force. Alternatively, in another embodiment, the force detector 18 may not be formed of a force sensor mounted on a wrist, but may be formed of one or more torque sensors provided at junctions of the links 11 to 16. The torque sensor detects torque acting on the links 11 to 16. The control device 3 or the teaching device 4 derives, from detection information of the force detector 18, magnitude and an action direction (i.e. a force parameter) of force applied to a work target, but is not limited thereto, and in another embodiment, may derive a parameter such as a position and a posture of a work target, a movement speed of a work target, a position and a posture of the control target part P of the machine 2, and a movement speed of the control target part P of the machine 2.

The machine 2 further includes the tool 19 that is attached to a tip of the machine 2. The tool 19 according to the present embodiment is formed of a welding tool for welding a work, but is not limited thereto, and in another embodiment, may be formed of a tool in another manner such as a hand tool, a coating tool, a deburring tool, a sealing tool, a cutting tool, a polishing tool, or a hemming tool. The machine 2 according to the present embodiment performs welding work of welding a work W1 to a work W2 while moving a welding tool along a predetermined operation trajectory, but is not limited thereto, and in another embodiment, may perform deburring work of performing deburring or polishing by pressing a work against a tool such as a deburring tool or a polishing tool while moving the work held by a hand tool along a predetermined operation trajectory, or a variety of work such as coating, scaling, cutting, and hemming of a work while moving a coating tool, a sealing tool, a cutting tool, a hemming tool, or the like along a predetermined operation trajectory.

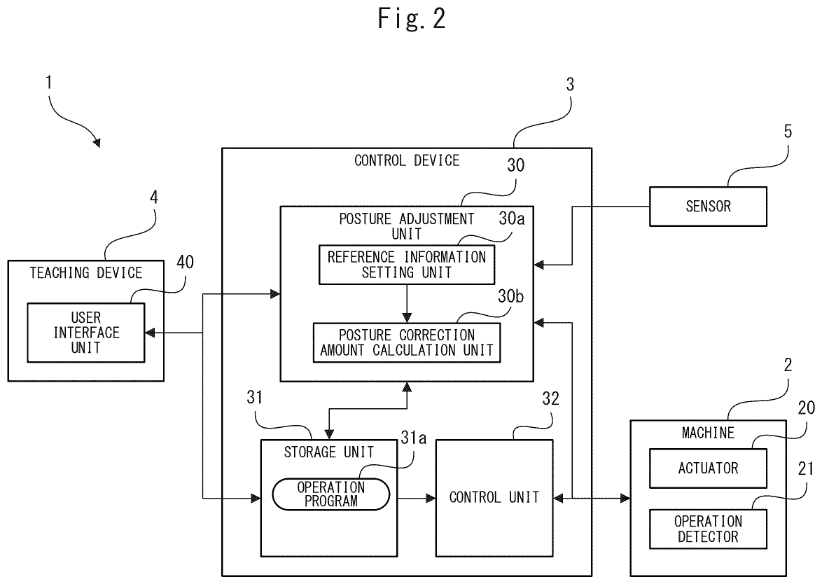

The machine 2 includes one or more actuators 20 that drive the links 11 to 16, and an operation detector 21 that detects operation of the actuator 20 (see FIG. 2). The actuator 20 is provided in a vicinity of each of coupling portions of the links 11 to 16. The actuator 20 is formed of an electric actuator including an electric motor, a speed reducer, or the like, but is not limited thereto, and in another embodiment, may be formed of another actuator such as a hydraulic or pneumatic actuator. The operation detector 21 is formed of an encoder, but is not limited thereto, and in another embodiment, may be formed of an operation detector in another manner such as a resolver or a Hall sensor. The control device 3 or the teaching device 4 detects an operation including a position, a speed, an acceleration, or the like of the actuator 20 from detection information of the operation detector 21, but is not limited thereto, and in another embodiment, may derive a position and a posture of the control target part P of the machine 2, a movement speed of the control target part P of the machine 2, or the like.

The control device 3 includes a programmable logic controller (PLC) or the like, but is not limited thereto, and in another embodiment, may be formed of a computer device in another manner including a processor, a memory, an input/output interface, and the like that are mutually connected by buses. The control device 3 includes a drive circuit that drives the actuator 20, but is not limited thereto, and in another embodiment, the machine 2 may include a drive circuit that drives the actuator 20. The control device 3 controls operation of the machine 2 by driving the actuator 20. The control device 3 receives, from the visual sensor 17, the force detector 18, the operation detector 21, and the like, detection information thereof, and controls operation of the machine 2, based on the detection information.

The control device 3 sets various coordinate systems such as a world coordinate system, a machine coordinate system, a flange coordinate system, a tool coordinate system, a camera coordinate system, and a user coordinate system. The coordinate systems are formed of, for example, orthogonal coordinate systems. In order to make description easy, it is assumed that a control device 3 has set a machine coordinate system C1, a tool coordinate system C2, and a user coordinate system C3. The machine coordinate system C1 is fixed at a reference position of the machine 2, for example, a base, the tool coordinate system C2 is fixed at a reference position of the tool 19, for example, the tool center point (TP), and the user coordinate system C3 is fixed at any position, for example, a reference position of the work W2.

It is assumed that the control device 3 sets an origin (i.e. a tool center point: TCP) of the tool coordinate system C2 to the control target part P (the tool 19 in the present example) of the machine 2. Therefore, a position and a posture of the control target part P of the machine 2 (also referred to as a position and a posture of the machine 2) are expressed as a position and a posture of the tool coordinate system C2 in the machine coordinate system C1, but are not limited thereto, and in another embodiment, a position and a posture of the control target part P may be expressed as a position and a posture of a flange coordinate system in the machine coordinate system C1, or may be expressed as the tool coordinate system C2 in the user coordinate system C3. The control device 3 controls operation of the machine 2 according to an operation program generated by the teaching device 4.

An operation program includes various control instructions such as a movement instruction for moving the control target part P of the machine 2 to a teaching point constituting the operation trajectory T of the machine 2, a force control instruction for controlling force to be applied to a work target, an application instruction that causes the machine 2 to execute a predetermined operation pattern (palletizing, depalletizing, and the like), a condition branch instruction for branching a control instruction under a predetermined condition, and a loop instruction for looping a predetermined control instruction under a predetermined condition. The movement instruction, the force control instruction, and the application instruction are examples of operation instructions for operating the control target part P.

The teaching device 4 is formed of a portable teaching pendant communicably connected wired or wireless to the control device 3, but is not limited thereto, and in another embodiment, may be formed of a computer device in another manner such as a teaching operation board directly attached to the control device 3, a tablet, a personal computer, or a server device. The teaching device 4 includes a processor, a memory, an input/output interface, a user interface, and the like that are mutually connected by a bus. The user interface is formed of display equipment such as a touch panel or a display, and input equipment such as a keyboard, a button, or a switch. The teaching device 4 includes program generation software for generating an operation program for the machine 2. The teaching device 4 sends the generated operation program to the control device 3.

In the mechanical system 1 configured as above, the control device 3 operates the machine 2 according to the operation program, and the machine 2 performs welding work of welding the first work W1 into the second work W2 by using the tool 19. Not only in such welding work but also in work utilizing the operation trajectory of the tool 19, such as coating work, deburring work, sealing work, cutting work, polishing work, and hemming work, work quality may deteriorate when a posture of the tool 19 changes rapidly. Therefore, the teacher teaches a posture of the tool 19 in such a way that a posture of the tool 19 does not change rapidly. However, it is not easy to teach a posture of the tool 19 in such a way that a posture of the tool 19 changes smoothly (i.e. in such a way that a posture change speed becomes substantially constant).

Accordingly, the mechanical system 1 of the present disclosure adjusts a posture of the tool 19 on an operation trajectory of the tool 19, based on reference information of a posture of the tool 19. In the mechanical system 1 according to the first embodiment, a posture correction amount of the tool 19 on an operation trajectory of the tool 19 is calculated based on reference information of a posture of the tool 19, and corrects, based on the posture correction amount, posture information of the tool 19 used in an operation program of the machine 2.

A functional block of the mechanical system 1 according to the first embodiment will be described below. FIG. 2 is a functional block diagram of the mechanical system 1 according to the first embodiment. The machine 2 includes one or more actuators 20 that drive a link, and one or more operation detectors 21 that detect operation of the actuator 20. The teaching device 4 includes a user interface (UI) unit 40 that performs teaching of operation of the machine 2 or checking of a state of the machine 2. The sensor 5 is formed of various sensors (the visual sensor 17, the force detector 18, and the like) for detecting various pieces of information.

The control device 3 includes a posture adjustment unit 30 that adjusts a posture of the tool 19, a storage unit 31 that stores various pieces of information such as an operation program 31a of the machine 2, and a position and a posture of the tool 19 used in the operation program 31a, and a control unit 32 that controls operation of one or more actuators 20 (i.e. the machine 2) according to the operation program 31a and detection information of the operation detector 21 or the sensor 5 (the visual sensor 17, the force detector 18, and the like).

The posture adjustment unit 30, a reference information setting unit 30a, and a posture correction amount calculation unit 30b are formed of one or more programs or program sections that are read and executed by a processor such as a PLC, a central processing unit (CPU), or a micro processing unit (MPU), but are not limited thereto, and in another embodiment, may be formed of one or more semiconductor integrated circuits.

The storage unit 31 is formed of a memory such as a random access memory (RAM), a read-only memory (ROM), and a solid state drive (SSD). The control unit 32 is formed of one or more programs or program sections that are read and executed by a processor such as a PLC, a CPU, or an MPU, but is not limited thereto, and in another embodiment, may be formed of one or more semiconductor integrated circuits or one or more drive circuits.

The posture adjustment unit 30 includes the reference information setting unit 30a that sets reference information of a posture of the tool 19, based on various pieces of input information of the UI unit 40, the operation detector 21, the sensor 5 (the visual sensor 17, the force detector 18, and the like), and the like, and a posture correction amount calculation unit 30b that calculates a posture correction amount of the tool 19 on an operation trajectory of the tool 19, based on the set reference information.

The posture adjustment unit 30 uses at least one of a reference point and a reference line as reference information for a posture of the tool 19. When the tool 19 moves along a curve, the reference information setting unit 30a sets a reference point as a rotation center point of the tool 19 on an operation trajectory of the tool 19. When the tool 19 moves along a curve in a state of maintaining predetermined posture information, the reference information setting unit 30a sets a reference line as a rotation center axis of the tool 19 on an operation trajectory of the tool 19.

When an operation trajectory of the tool 19 is formed of a curve, a straight line, or a combination thereof, the reference information setting unit 30a sets reference information for each teaching point constituting the operation trajectory or for each operation interval. Therefore, the reference information setting unit 30a associates and records the reference information for each teaching point constituting the operation trajectory of the tool 19 or for each operation interval. In other words, the reference information setting unit 30a preferably switches and sets reference information for each teaching point constituting the operation trajectory of the tool 19 or for each operation interval.

When reference information is a reference point, the posture adjustment unit 30 adjusts a posture of the tool 19 with the reference point as a rotation center point of the tool 19 on an operation trajectory of the tool 19. In other words, the posture correction amount calculation unit 30b calculates a posture correction amount for correcting a posture of the tool 19 in a direction of a straight line in which a posture vector of the tool 19 passes through the reference point and a position of the tool 19 on the operation trajectory of the tool 19. More specifically, the posture correction amount calculation unit 30b rotates a posture vector of the tool 19 around a correction rotation axis being perpendicular to a plane in which the posture vector of the tool 19 before posture adjustment and the reference point exist and passing through the position of the tool 19 on the operation trajectory of the tool 19, and calculates a posture correction amount in which the posture vector passes through the reference point.

When the reference information is the reference line, the posture adjustment unit 30 adjusts the posture of the tool 19 with the reference line as the rotation center axis of the tool 19 on the operation trajectory of the tool 19. In other words, the posture correction amount calculation unit 30b calculates a posture correction amount for correcting a posture of the tool 19 in a direction in which the posture vector of the tool 19 passes through the position of the tool 19 on the operation trajectory of the tool 19 and intersects the reference line. More specifically, the posture correction amount calculation unit 30b rotates the posture vector of the tool 19 around a correction rotation axis being parallel to the reference line and passing through the position of the tool 19 on the operation trajectory of the tool 19, and calculates a posture correction amount for correcting a posture of the tool 19 in the direction in which the posture vector intersects the reference line.

The posture correction amount calculation unit 30b calculates a posture correction amount for each position of the tool 19 on the operation trajectory of the tool 19. In addition, when an operation trajectory of the tool 19 is formed of a curve, a straight line, or a combination thereof, the posture correction amount calculation unit 30b calculates a posture correction amount by switching reference information for each position of the tool 19 on the operation trajectory of the tool 19 or for each operation interval.

In the first embodiment, the posture correction amount calculation unit 30b corrects, based on the calculated posture correction amount, posture information of the tool 19 used in the operation program 31a. Note that, the position information of the tool 19 used in the operation program 31a is not corrected by the posture correction amount calculation unit 30b. The control unit 32 controls operation of the machine 2 according to the operation program 31a using the corrected posture of the tool 19.

As described above, when the tool 19 moves along a curve, a posture of the tool 19 is automatically adjusted based on a reference point, and when the tool 19 moves along the curve while maintaining predetermined posture information, a posture of the tool 19 is automatically adjusted based on a reference line. In addition, when an operation trajectory of the tool 19 is formed of a curve, a straight line, or a combination thereof, a posture of the tool 19 is automatically adjusted based on a combination of a reference point and a reference line.

Therefore, even when an operation trajectory of the tool 19 is a complicated trajectory, a posture of the tool 19 can be changed smoothly with simple teaching compared to heretofore regardless of experience of a teacher. In other words, a rapid posture change of the tool 19 is suppressed. As a consequence, a difference in work quality due to a difference in a skill level of a teacher is reduced.

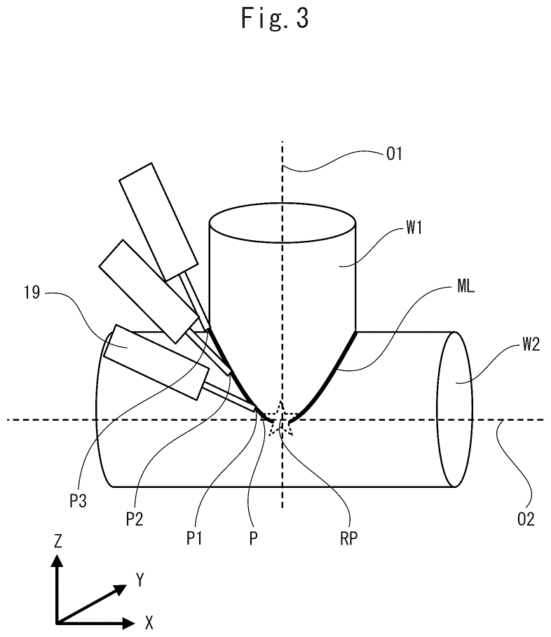

An example of adjusting a posture of the tool 19 according to a reference point will be described in detail below. FIG. 3 is an explanatory diagram describing one example of work for performing posture adjustment according to a reference point. FIG. 3 illustrates a welding operation in which the cylindrical first work W1 is welded in a state of being orthogonal to the cylindrical second work W2. Since a machining line ML is formed of a curve, an operation trajectory of the tool 19 is also formed of a curve along the machining line ML.

When the tool 19 moves along a curve, the reference information setting unit 30a sets a reference point RP as a rotation center point of the tool 19 on an operation trajectory of the tool 19. In the present example, the reference point RP is set at an intersection of a center axis line O1 of the first work W1 and a center axis line O2 of the second work W2. The posture adjustment unit 30 adjusts a posture of the tool 19 with the reference point RP as a rotation center point of the tool 19 on an operation trajectory of the tool 19.

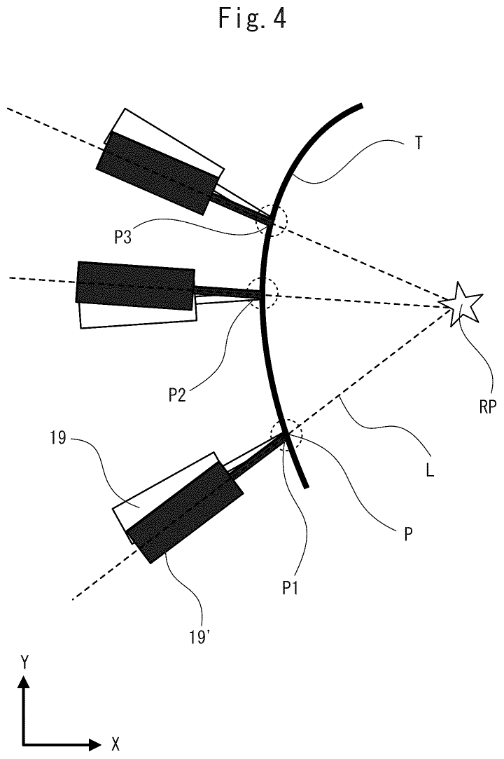

FIG. 4 is a top view of the tool 19 (illustrated in white) before posture adjustment according to the reference point RP and the tool 19′ (illustrated in black) after posture adjustment. The posture correction amount calculation unit 30b calculates a posture correction amount for correcting a posture of the tool 19 in a direction of the straight line L in which a posture vector of the tool 19 passes through the reference point RP and the teaching points P1 to P3 constituting an operation trajectory of the tool 19.

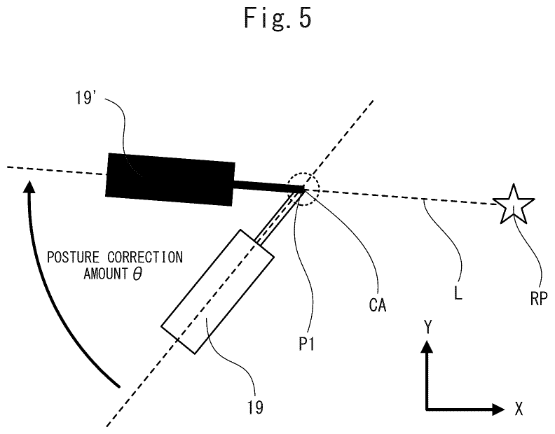

FIG. 5 is a top view of the tool 19 illustrating one example of a posture correction amount θ according to the reference point RP. The posture correction amount calculation unit 30b rotates a posture vector of the tool 19 around a correction rotation axis CA being perpendicular to a plane in which a posture vector of the tool 19 before posture adjustment and the reference point RP exist and passing through the teaching point P1, and calculates the posture correction amount θ in which the posture vector passes through the reference point RP. Since the posture correction amount θ is a one-dimensional rotation amount around the correction rotation axis CA, a teacher can easily imagine a posture of the tool 19′ after posture adjustment.

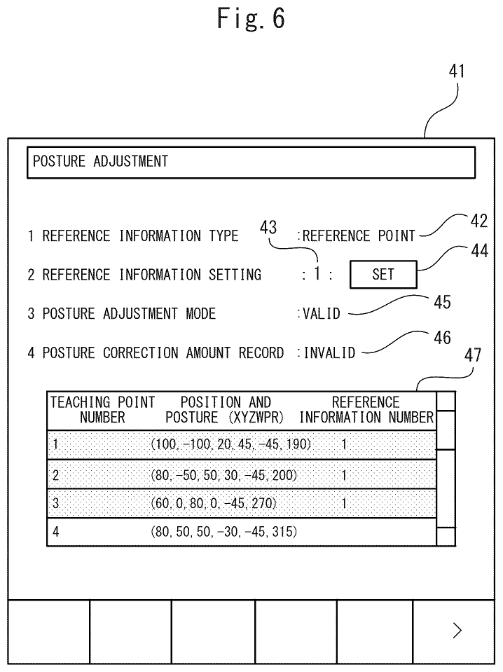

When performing posture adjustment according to the reference point RP as described above, a teacher performs setting of posture adjustment in advance by using the teaching device 4. FIG. 6 is a diagram illustrating one example of a posture adjustment screen 41 according to the reference point RP. The posture adjustment screen 41 is generated by the posture adjustment unit 30 and displayed on the UI unit 40. The posture adjustment screen 41 includes a setting function for a reference information type 42, a reference information setting button 44, a posture adjustment mode 45, a posture correction amount record 46, and a trajectory history table 47. The setting function of the reference information type 42 and the reference information setting 44 is achieved by the reference information setting unit 30a, and the setting function of the posture adjustment mode 45, the posture correction amount record 46, and the trajectory history table 47 is achieved by the posture correction amount calculation unit 30b.

When performing posture adjustment according to the reference point RP, the teacher sets the reference information type 42 to “reference point”. When the reference information type 42 is set, “1” being a reference information number 43 for identifying the reference point RP is automatically allocated to reference information. In other words, the reference information setting unit 30a is configured in such a way that a plurality of reference points can be set for one operation trajectory of the tool 19.

Next, the teacher displays a non-illustrated reference information setting window by pressing the reference information setting button 44, and sets the reference point RP in the reference information setting window.

For example, the following methods can be given as setting methods of the reference point RP.
(1) A teacher inputs a position (X, Y, Z) of one point. The reference information setting unit 30a sets the input point as the reference point RP.
(2) A teacher inputs positions (X, Y, Z) of two points. The reference information setting unit 30a sets a middle point between the two points as the reference point RP.
(3) A teacher inputs a position and a posture (X, Y, Z, W, P, R) of one point, and a distance. The reference information setting unit 30a sets, as the reference point RP, a point being in the same direction as a vector of a posture acquired from the posture (W, P, R) and being located at a distance specified from the position (X, Y, Z) on a straight line passing through the position (X, Y, Z).
(4) A teacher inputs positions (X, Y, Z) of two points and a distance. The reference information setting unit 30a sets, as the reference point RP, a point located at a specified distance from one point on a straight line connecting the two points.
(5) A teacher inputs positions (X, Y, Z) of three points. The reference information setting unit 30a sets, as the reference point RP, a center point of a circle passing through the three points.
(6) A teacher inputs four or more positions (X, Y, Z). After calculating a center point of a circle passing through the three points for each combination of the three points, the reference information setting unit 30a sets an average position of center points of all circles as the reference point RP.

In addition, for example, the following methods can be given as input methods of original information (information such as a position and a posture of the point, or a distance) of the reference point RP.
(1) Original information of the reference point RP is input by actually moving the machine 2 by using the teaching device 4 and touching up the tool 19 on a work target. Alternatively, original information of the reference point RP is input by moving a model of the machine 2 in a virtual space by using the teaching device 4 and touching up the tool 19 on a model of the work target.
(2) A numerical value of original information of the reference point RP is directly manually input on the teaching device 4.
(3) The machine 2 is actually moved by using the teaching device 4, and original information of the reference point RP is automatically input from detection information of the operation detector 21 and the sensor 5 (the visual sensor 17, the force detector 18, and the like). Alternatively, a model of the machine 2 is moved in the virtual space by using the teaching device 4, and original information of the reference point RP is automatically input from detection information of the model of the operation detector 21.

Next, a teacher sets the posture adjustment mode 45 to “valid”. In a case where the posture adjustment mode 45 is set to “valid”, when the teacher teaches an operation trajectory of the tool 19, or when the already taught teaching points P1, P2, and P3 or the operation intervals P1 to P3 are selected on the trajectory history table 47, the posture correction amount calculation unit 30b calculates the posture correction amount θ of the tool 19, based on the reference point RP and a position and a posture (X, Y, Z, W, P, R) of the teaching points P1 to P3 constituting an operation trajectory of the tool 19, and overwrites, based on the posture correction amount θ, information of the posture (W, P, R) of the tool 19 used in the operation program 31a of the machine 2.

On the other hand, when a teacher sets the posture adjustment mode 45 to “invalid”, the posture correction amount calculation unit 30b neither calculates the posture correction amount θ of the tool 19, nor overwrites information of the posture (W, P, R) of the control target part P used in the operation program 31a of the machine 2.

In addition, when the calculated posture correction amount θ is not recorded, the teacher sets the posture correction amount record 46 to “invalid”. When the posture correction amount record 46 is set to “invalid”, the posture correction amount θ is not recorded, and thus overwritten information of the posture (W, P, R) used in the operation program 31a may not be restored.

On the other hand, when recording the calculated posture correction amount θ, a teacher sets the posture correction amount record 46 to “valid”. When the posture correction amount record 46 is set to “valid”, the posture adjustment unit 30 records the posture correction amount θ for each position of the tool 19 on the operation trajectory of the tool 19. When the posture adjustment mode 45 is changed from “valid” to “invalid”, the posture adjustment unit 30 restores, based on the recorded posture correction amount θ, overwritten information of the posture (W, P, R) used in the operation program 31a.

As described above, a teacher simply sets the reference point RP on the posture adjustment screen 41 and sets the posture adjustment mode 45 to “valid”, and a posture of the tool 19 is automatically adjusted based on the reference point RP. Therefore, even when the tool 19 moves along a curve, a posture of the tool 19 is changed smoothly with simple teaching compared to heretofore regardless of experience of a teacher. In other words, a rapid posture change of the tool 19 is suppressed. As a consequence, a difference in work quality due to a difference in a skill level of a teacher is reduced.

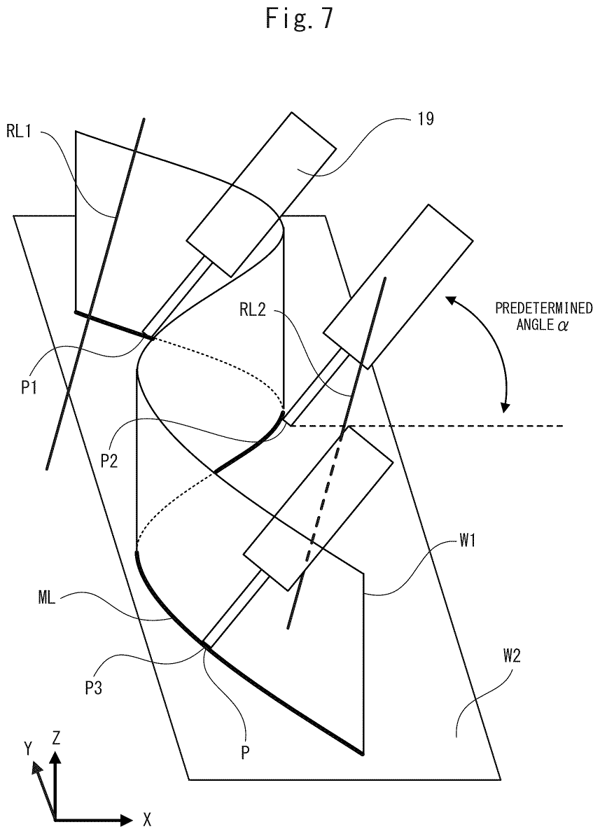

An example of adjusting a posture of the tool 19 according to a reference line will be described in detail below. FIG. 7 is an explanatory diagram describing one example of work for performing posture adjustment according to a reference line. FIG. 7 illustrates welding work in which the S-shaped first work W1 is welded in a state of being orthogonal to the plate-shaped second work W2. Since the machining line ML is formed of a curve, the operation trajectory of the tool 19 is also formed of a curve along the machining line ML. It is assumed that a posture of the tool 19 is taught at a predetermined angle α in advance in such a way that the tool 19 does not interfere with the first work W1 or the second work W2.

When the tool 19 moves along a curve in a state of maintaining the predetermined angle α, the reference information setting unit 30a sets the reference lines RL1 and RL2 as a rotation center axis of the tool 19 on an operation trajectory of the tool 19. In the present example, the two reference lines RL1 and RL2 are set for each peak of a curve constituting the machining line ML. The posture adjustment unit 30 adjusts a posture of the tool 19 with the two reference lines RL1 and RL2 as the rotation center axes of the tool 19 on the operation trajectory of the tool 19.

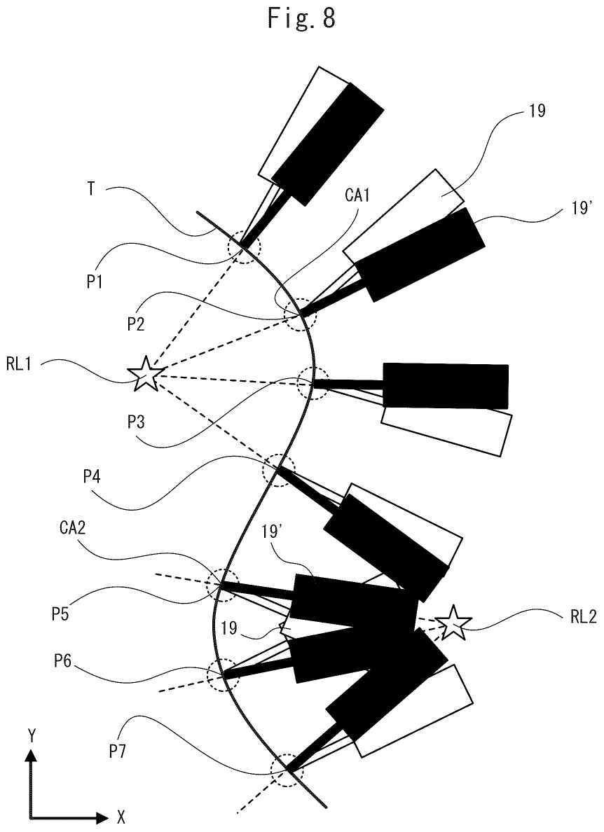

FIG. 8 is a top view of the tool 19 (illustrated in white) before posture adjustment and the tool 19′ (illustrated in black) after posture adjustment according to the reference lines RL1 and RL2. The posture correction amount calculation unit 30b calculates a posture correction amount for correcting a posture of the tool 19 in a direction in which a posture vector of the tool 19 passes through the teaching points P1 to P3 constituting the operation trajectory of the tool 19 and intersects the first reference line RL1. Similarly, the posture correction amount calculation unit 30b calculates a posture correction amount for correcting a posture of the tool 19 in a direction in which a posture vector of the tool 19 passes through the teaching points P4 to P7 constituting the operation trajectory of the tool 19 and intersects the second reference line RL2.

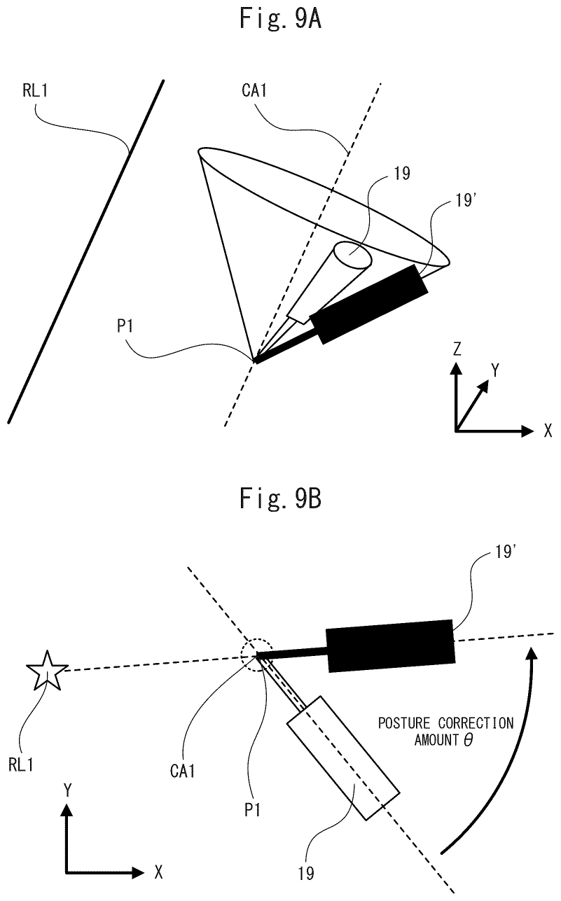

FIG. 9A is a perspective view of the tool 19 illustrating one example of the posture correction amount θ corresponding to the reference line RL1, and FIG. 9B is a top view of the tool 19 illustrating one example of the posture correction amount θ corresponding to the reference line RL1. The posture correction amount calculation unit 30b rotates a posture vector of the tool 19 around a correction rotation axis CA1 being parallel to the reference line RL1 and passing through the teaching point P1 constituting the operation trajectory of the tool 19, and calculates the posture correction amount θ for correcting a posture of the tool 19 in a direction in which the posture vector intersects the reference line RL1. Since the posture correction amount θ is a one-dimensional rotation amount around the correction rotation axis CA1, a teacher can easily imagine a posture of the tool 19′ after posture adjustment.

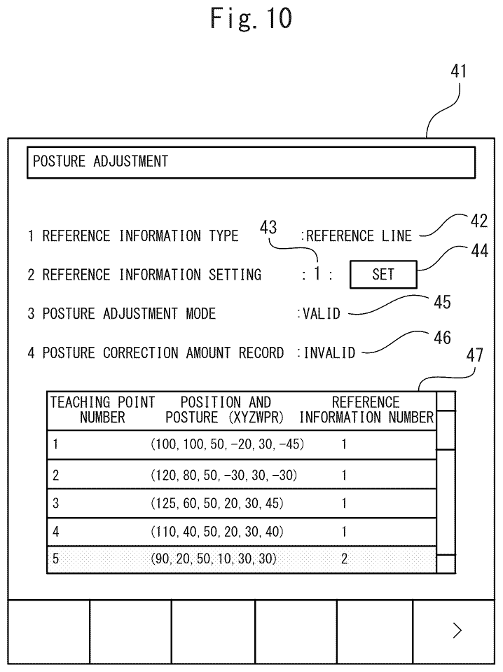

When performing posture adjustment according to the reference lines RL1 and RL2 as described above, a teacher performs setting of posture adjustment in advance by using the teaching device 4. FIG. 10 is a diagram illustrating one example of the posture adjustment screen 41 corresponding to the reference lines RL1 and RL2. The posture adjustment screen 41 is generated by the posture adjustment unit 30 and displayed on the UI unit 40. The posture adjustment screen 41 includes a setting function for the reference information type 42, the reference information setting button 44, the posture adjustment mode 45, the posture correction amount record 46, and the trajectory history table 47. The setting function of the reference information type 42 and the reference information setting button 44 is achieved by the reference information setting unit 30a, and the setting function of the posture adjustment mode 45, the posture correction amount record 46, and the trajectory history table 47 is achieved by the posture correction amount calculation unit 30b.

When performing posture adjustment according to the reference lines RL1 and RL2, a teacher sets the reference information type 42 to “reference line”. When the reference information type 42 is set, “2” being the reference information number 43 for identifying the reference line RL2 is automatically allocated to reference information. In other words, the reference information setting unit 30a is configured in such a way that a plurality of reference lines can be set for one operation trajectory of the tool 19.

In the present example, the reference line RL1 has already been set, and the teacher displays a non-illustrated reference information setting window by pressing the reference information setting button 44, and sets the reference line RL2 in the reference information setting window.

For example, the following methods can be given as setting methods of the reference line RL2.
(1) A teacher inputs a position and a posture (X, Y, Z, W, P, R) of one point. The reference information setting unit 30a sets, as the reference line RL2, a straight line passing through the position and posture (X, Y, Z, W, P, R) of the input point.
(2) A teacher inputs positions (X, Y, Z) of two points. The reference information setting unit 30a sets, as the reference line RL2, a straight line passing through the two points.

In addition, for example, the following methods can be given as input methods of original information of the reference line RL2 (information such as a position and a posture of the point).
(1) Original information of the reference line RL2 is input by actually moving the machine 2 by using the teaching device 4 and touching up the tool 19 on a work target. Alternatively, original information of the reference line RL2 is input by moving a model of the machine 2 in a virtual space by using the teaching device 4 and touching up the tool 19 on a model of a work target.
(2) A numerical value of original information of the reference line RL2 is directly manually input on the teaching device 4.
(3) The machine 2 is actually moved by using the teaching device 4, and original information of the reference line RL2 is automatically input from detection information of the operation detector 21 and the sensors 5 (the visual sensor 17, the force detector 18, and the like). Alternatively, original information of the reference line RL2 is automatically input from detection information of a model of the operation detector 21 by moving a model of the machine 2 in a virtual space by using the teaching device 4.

Next, a teacher sets the posture adjustment mode 45 to “valid”. In a case where the posture adjustment mode 45 is set to “valid”, when the teacher teaches an operation trajectory of the tool 19, or when an already taught teaching point or operation interval is selected on the trajectory history table 47, the posture correction amount calculation unit 30b calculates the posture correction amount θ of the tool 19, based on the reference line RL2 and a position and a posture (X, Y, Z, W, P, R) of the teaching point P5 constituting an operation trajectory of the tool 19, and overwrites, based on the calculated posture correction amount θ, information of the posture (W, P, R) of the control target part P used in the operation program 31a of the machine 2.

On the other hand, when a teacher sets the posture adjustment mode 45 to “invalid”, the posture correction amount calculation unit 30b neither calculates the posture correction amount θ of the tool 19, nor overwrites information of the posture (W, P, R) of the tool 19 used in the operation program 31a of the machine 2.

In addition, when the calculated posture correction amount θ is not recorded, the teacher sets the posture correction amount record 46 to “invalid”. When the posture correction amount record 46 is set to “invalid”, the posture correction amount θ is not recorded, and thus overwritten information of the posture (W, P, R) of the tool 19 used in the operation program 31a may not be restored.

On the other hand, when recording the calculated posture correction amount θ, a teacher sets the posture correction amount record 46 to “valid”. When the posture correction amount record 46 is set to “valid”, the posture adjustment unit 30 records the posture correction amount θ for each position of the tool 19 on the operation trajectory of the tool 19. When the posture adjustment mode 45 is changed from “valid” to “invalid”, the posture adjustment unit 30 restores, based on the recorded posture correction amount θ, overwritten information of the posture (W, P, R) of the tool 19 used in the operation program 31a.

As described above, a teacher simply sets the reference lines RL1 and RL2 on the posture adjustment screen 41 and sets the posture adjustment mode 45 to “valid”, and a posture of the tool 19 is automatically adjusted based on the reference lines RL1 and RL2. Therefore, even when the tool 19 moves along a curve in a state of maintaining the predetermined angle α, a posture of the tool 19 is changed smoothly with simple teaching compared to heretofore regardless of experience of a teacher. In other words, a rapid posture change of the tool 19 is suppressed. As a consequence, a difference in work quality due to a difference in a skill level of a teacher is reduced.

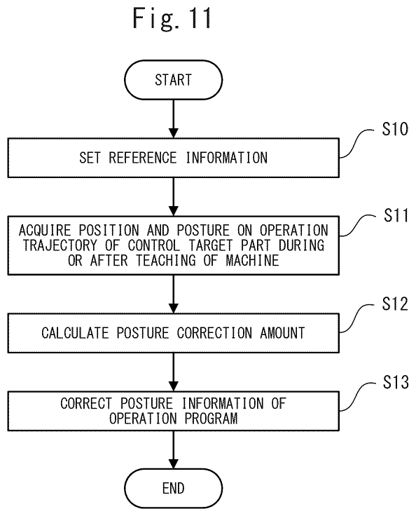

One example of the posture adjustment method according to the first embodiment will be described below. FIG. 11 is a flowchart illustrating one example of a posture adjustment method according to the first embodiment. In step S10, reference information including at least one of a reference point and a reference is set. Setting of reference information is performed on the posture adjustment screen 41 described above. In step S11, a position and a posture of the tool 19 on the operation trajectory of the tool 19 are acquired during or after teaching of the machine 2.

For example, the following methods can be given as acquisition methods of a position and a posture of the tool 19 on an operation trajectory of the tool 19.
(1) The machine 2 is actually moved by using the teaching device 4, or a model of the machine 2 is moved in a virtual space by using the teaching device 4, and a position and a posture (X, Y, Z, W, P, R) of the tool 19 on an operation trajectory of the tool 19 are acquired.
(2) Numerical values of a position and a posture (X, Y, Z, W, P, R) of the tool 19 on the operation trajectory of the tool 19 are directly manually input on the teaching device 4.
(3) The machine 2 is actually moved by using the teaching device 4, or a model of the machine 2 is moved in a virtual space by using the teaching device 4, and a position and a posture (X, Y, Z, W, P, R) of the tool 19 on an operation trajectory of the tool 19 are automatically input from detection information of the operation detector 21 or the sensor 5 (the visual sensor 17, the force detector 18, and the like).
(4) Acquired from information of the position and posture (X, Y, Z, W, P, R) of the tool 19 on the operation trajectory of the tool 19 used in the generated operation program 31a.

In step S12, a posture correction amount of the tool 19 is calculated from reference information and a position and a posture of the tool 19 on an operation trajectory of the tool 19. In step S13, information of a posture (W, P, R) used in the operation program 31a is corrected based on a posture correction amount. Note that, in step S12 or step S13, a posture correction amount may be recorded in such a way that overwritten information of the posture (W, P, R) of the operation program 31a can be restored.

As described above, in the posture adjustment method according to the first embodiment, since information of the posture (W, P, R) of the tool 19 used in the operation program 31a during or after teaching of the machine 2 is corrected, a rapid posture change of the tool 19 is suppressed with simple teaching compared to heretofore regardless of experience of a teacher. As a consequence, a difference in work quality due to a difference in a skill level of a teacher is reduced.

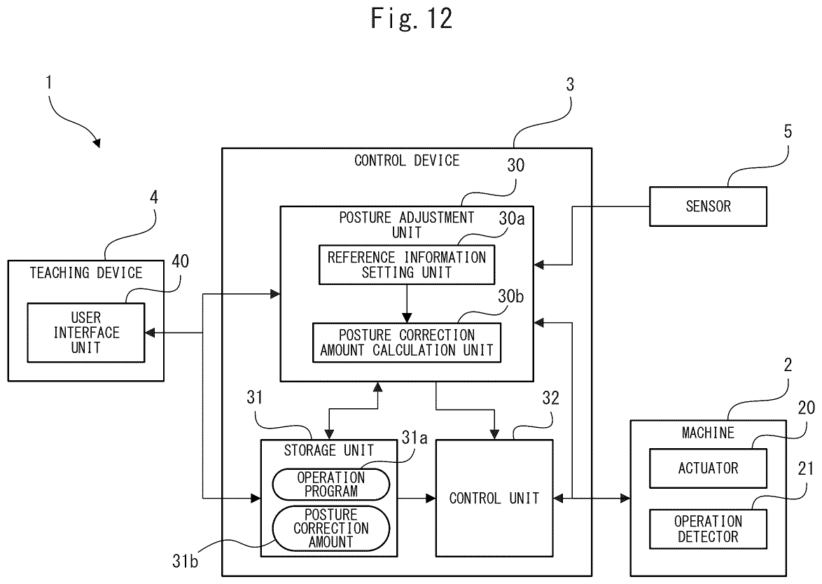

A functional block of a mechanical system 1 according to a second embodiment will be described below. FIG. 12 is a functional block diagram of the mechanical system 1 according to the second embodiment. The mechanical system 1 according to the second embodiment is different from the mechanical system 1 according to the first embodiment in that a posture adjustment unit 30 calculates a posture correction amount 31b of a tool 19 during operation of the machine 2, and a control unit 32 corrects, based on the posture correction amount 31b, a posture of the tool 19 during operation of a machine 2. In addition, the posture adjustment unit 30 may record the calculated posture correction amount 31b in the storage unit 31, and a control unit 32 may correct a posture of the tool 19, based on the recorded posture correction amount 31b in and after a second operation of the machine 2.

In the second embodiment, a teacher sets at least one of a reference point and a reference line in advance on a posture adjustment screen 41 as illustrated in FIGS. 6 and 10. In addition, the teacher sets the posture adjustment mode 45 to “valid”. In a case where the posture adjustment mode 45 is set to “valid”, when the control unit 32 controls operation of the machine 2 according to the operation program 31a and detection information of an operation detector 21 or a sensor 5 (a visual sensor 17, a force detector 18, and the like), a posture correction amount calculation unit 30b calculates a posture correction amount 31b of the tool 19, based on reference information including at least one of a reference point and a reference line, and a position and a posture (X, Y, Z, W, P, R) of the tool 19 on an operation trajectory of the tool 19, and the control unit 32 corrects, based on the posture correction amount 31b, a posture of the tool 19 during operation of the machine 2.

On the other hand, when the posture adjustment mode 45 is set to “invalid”, the posture correction amount calculation unit 30b does not calculate the posture correction amount 31b of the tool 19 during operation of the machine 2 is operating, and the control unit 32 does not correct a posture of the tool 19 during operation of the machine 2.

In addition, when using the previously calculated posture correction amount 31b of the tool 19 is used in and after a second operation of the machine 2, a teacher sets a posture correction amount record 46 to “valid”. In a case where the posture correction amount record 46 is set to “valid”, the posture correction amount calculation unit 30b records the posture correction amount 31b in the storage unit 31 when calculating the posture correction amount 31b during operation of the machine 2, and the control unit 32 corrects, based on the recorded past posture correction amount 31b, a posture of the tool 19 during operation of the machine 2.

On the other hand, when the posture correction amount record 46 is set to “invalid”, the posture correction amount calculation unit 30b recalculates the posture correction amount 31b of the tool 19 each time the machine 2 operates, and the control unit 32 corrects, based on the recalculated posture correction amount 31b, a posture of the tool 19 during operation of the machine 2. In other words, even when a position and a posture of the tool 19 are changed by another function during execution of the operation program 31a of the machine 2, the control unit 32 corrects, based on the recalculated posture correction amount 31b of the tool 19, a posture of the tool 19 during operation of the machine 2, and thus a rapid posture change of the tool 19 is suppressed regardless of presence or absence of a change in a position and a posture of the tool 19 by another function.

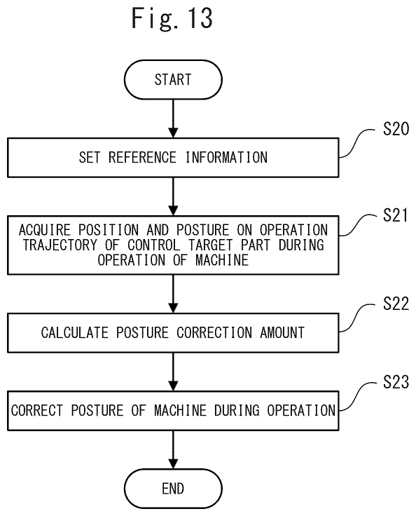

One example of a posture adjustment method according to the second embodiment will be described below. FIG. 13 is a flowchart illustrating one example of the posture adjustment method according to the second embodiment. In step S20, reference information including at least one of a reference point and a reference line is set. Setting of the reference information is performed on the posture adjustment screen 41 described above. In step S21, a position and a posture of the tool 19 on an operation trajectory of the tool 19 are acquired during operation of the machine 2.

For example, the following methods can be given as acquisition methods of a position and a posture of the tool 19 on an operation trajectory of the tool 19.
(1) Acquired from information of a position and a posture (X, Y, Z, W, P, R) of the tool 19 used in the generated operation program 31a.
(2) A position and a posture (X, Y, Z, W, P, R) of the tool 19 on an operation trajectory of the tool 19 are automatically input from detection information of the operation detector 21 or the sensor 5 (the visual sensor 17, the force detector 18, and the like) during operation of the machine 2.

In step S22, a posture correction amount is calculated from reference information and a position and a posture of the tool 19 on an operation trajectory of the tool 19. In step S23, a posture (W, P, R) of the control target part P is corrected during operation of the machine 2, based on the posture correction amount of the tool 19. Note that, in step S22 or step S23, a posture correction amount may be recorded in such a way that a posture of the tool 19 can be corrected in and after a second operation of the machine 2.

As described above, in the posture adjustment method according to the second embodiment, since a posture (W, P, R) of the tool 19 is corrected during operation of the machine 2, a rapid posture change of the tool 19 is suppressed even when a position and a posture of the tool 19 are changed by another function during execution of the operation program 31a. As a consequence, a difference in work quality due to presence or absence of a change in a position and a posture of the tool 19 by another function is reduced.

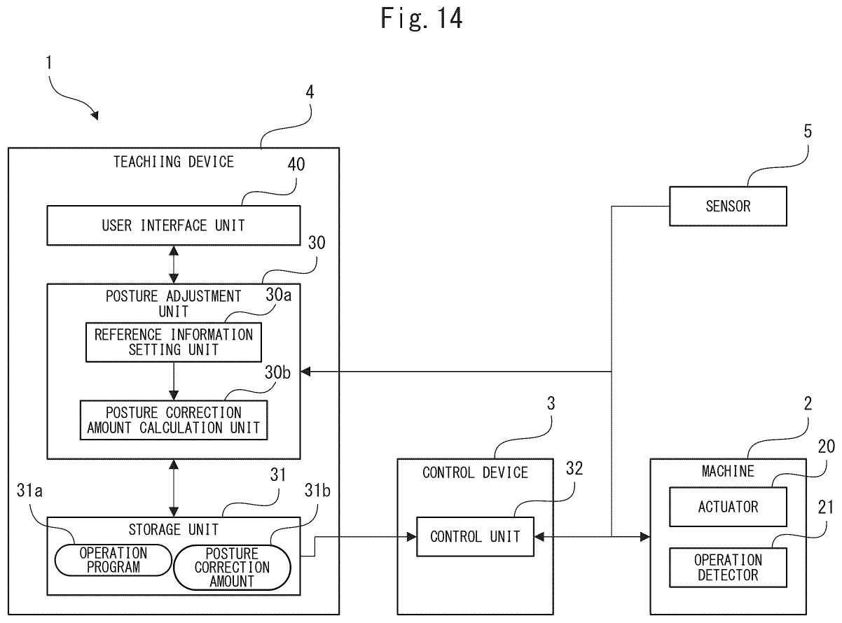

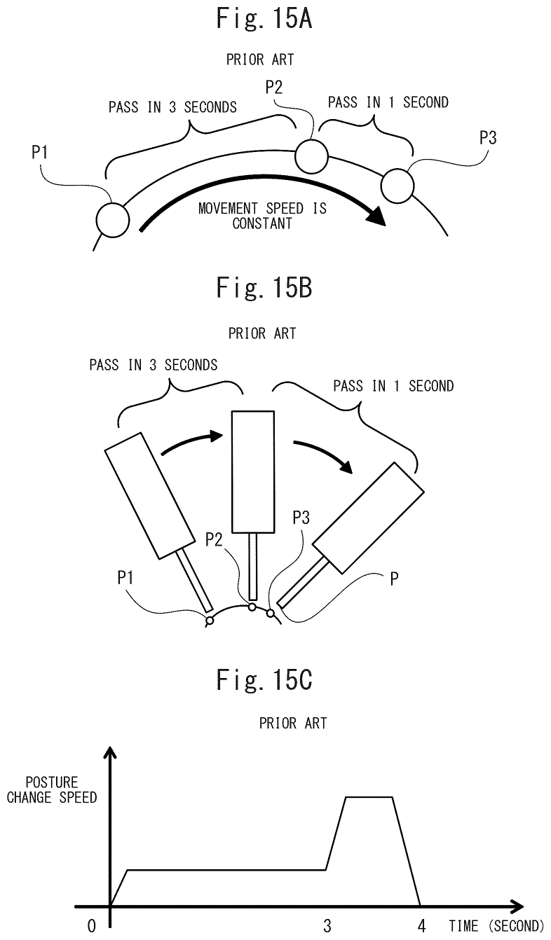

A functional block of a mechanical system 1 according to a third embodiment will be described below. FIG. 14 is a functional block diagram of the mechanical system 1 according to the third embodiment. The mechanical system 1 according to the third embodiment is different from the mechanical system 1 according to the first or second embodiment in that a control device 3 does not include a posture adjustment unit 30 for adjusting a posture of a tool 19, but a teaching device 4 includes the posture adjustment unit 30. In addition, although it is not necessary, the teaching device 4 may further include a storage unit 31 that stores various pieces of information such as the operation program 31a and a posture correction amount 31b. Note that, since the posture adjustment method according to the third embodiment is the same as one of the posture adjustment methods according to the first and second embodiments, description thereof will be omitted.

According to the above embodiment, a difference in a posture change speed of the tool 19 for each operation instruction is automatically lessened, and the tool 19 changes at a substantially constant posture change speed. In other words, since a rapid posture change of the tool 19 is suppressed, deterioration of work quality resulting from the machine 2 can be suppressed.

In addition, when posture information of the tool 19 used by the operation program 31a is corrected during or after teaching of the machine 2, a rapid posture change of a control target part P is suppressed with simple teaching compared to heretofore regardless of experience of a teacher. As a consequence, a difference in work quality due to a difference in a skill level of a teacher is reduced.

Furthermore, in a case where a posture of the tool 19 is corrected during operation of the machine 2, even when a position and a posture of the tool 19 are changed by another function during execution of the operation program 31a, a rapid posture change of the tool 19 is suppressed. As a consequence, a difference in work quality due to presence or absence of a change in a position and a posture of the tool 19 by another function is reduced.

Note that, the program or software described above may be provided by being recorded on a computer-readable non-transitory recording medium such as a CD-ROM, or may be distributed and provided from a server device on a wide area network (WAN) or a local area network (LAN) in a wired or wireless manner.

While various embodiments have been described in the present specification, the present invention is not limited to the embodiments described above, and it will be understood that various modifications can be made within the scope of the claims below.

### REFERENCE SIGNS LIST

1 Mechanical system (robot system)
2 Machine (robot)
3 Control device
4 Teaching device
5 Sensor
10 to 16 Link
17 Visual sensor
18 Force detector
19 Tool
19′ Tool after posture adjustment
20 Actuator
21 Operation detector
30 Posture adjustment unit
30a Reference information setting unit
30b Posture correction amount calculation unit
31 Storage unit
31a Operation program
31b Posture correction amount
32 Control unit
40 User interface unit
41 Posture adjustment screen
42 Reference information type
43 Reference information number
44 Reference information setting
45 Posture adjustment mode
46 Posture correction amount record
47 Trajectory history table
C1 Machine coordinate system
C2 Tool coordinate system
C3 User coordinate system
CA, CA1, CA2 Correction rotation axis
J1 to J6 Axis line
ML Machining line
O1, O2 Center axis line of work
P Control target part
P1 to P4 Teaching point
RP Reference point
RL1, RL2 Reference line
T Operation trajectory
W1, W2 Work
α Predetermined angle
θ Posture correction amount

1. A control device comprising:
a posture adjustment unit configured to adjust, based on reference information of a posture of a control target part of a machine, the posture of the control target part on an operation trajectory of the control target part; and
a control unit configured to control an operation of the machine, based on the adjusted posture,
wherein the posture adjustment unit uses at least one of a reference point and a reference line as the reference information.

2. The control device according to claim 1, wherein, when the reference information is the reference point, the posture adjustment unit adjusts the posture of the control target part with the reference point as a rotation center point of the control target part on the operation trajectory of the control target part.

3. The control device according to claim 1, wherein, when the reference information is the reference line, the posture adjustment unit adjusts the posture of the control target part with the reference line as a rotation center axis of the control target part on the operation trajectory of the control target part.

4. The control device according to claim 1, wherein the posture adjustment unit includes:
a reference information setting unit configured to set the reference information; and
a posture correction amount calculation unit configured to calculate a posture correction amount of the control target part, based on the reference information and a position and the posture of the control target part on the operation trajectory of the control target part.

5. The control device according to claim 4, wherein, when the reference information is the reference point, the posture correction amount calculation unit rotates a posture vector of the control target part around a correction rotation axis being perpendicular to a plane in which a posture vector of the control target part before posture adjustment and the reference point exist and passing through a position of the control target part on the operation trajectory of the control target part, and calculates a posture correction amount in which the posture vector passes through the reference point.

6. The control device according to claim 4, wherein, when the reference information is the reference line, the posture correction amount calculation unit rotates a posture vector of the control target part around a correction rotation axis being parallel to the reference line and passing through a position of the control target part on the operation trajectory of the control target part, and calculates a posture correction amount for correcting the posture of the control target part in a direction in which the posture vector intersects the reference line.

7. The control device according to claim 4, wherein the reference information setting unit associates and records the reference information for each teaching point constituting the operation trajectory of the control target part or for each operation interval, or switches and sets the reference information for each teaching point constituting the operation trajectory or for each operation interval.

8. The control device according to claim 4, wherein the posture correction amount calculation unit calculates the posture correction amount by switching the reference information for each position of the control target part on the operation trajectory of the control target part or for each operation interval of the control target part.

9. The control device according to claim 4, wherein the posture correction amount calculation unit records the posture correction amount of the control target part.

10. The control device according to claim 4, wherein the posture correction amount calculation unit calculates the posture correction amount of the control target part during or after teaching of the machine, and corrects the posture information of the control target part used in an operation program of the machine.

11. The control device according to claim 4, wherein the posture correction amount calculation unit calculates the posture correction amount of the control target part during operation of the machine, and the control unit corrects the posture of the control target part during operation of the machine, based on the posture correction amount.

12. A teaching device comprising a posture adjustment unit configured to adjust, based on reference information of a posture of a control target part of a machine, the posture of the control target part on an operation trajectory of the control target part, wherein the posture adjustment unit uses at least one of a reference point and a reference line as the reference information.

13. A mechanical system comprising:
a machine;
a posture adjustment unit configured to adjust, based on reference information of a posture of a control target part of the machine, the posture of the control target part on an operation trajectory of the control target part; and
a control unit configured to control an operation of the machine, based on the adjusted posture,
wherein the posture adjustment unit uses at least one of a reference point and a reference line as the reference information.
